(19) United States
(12) Patent Application Publication
(10) Pub. No.: US 2008/0028302 A1
(43) Pub. Date: Jan. 31, 2008

(54) Method and apparatus for incrementally updating a web page

(76) Inventor: Steffen Meschkat, New York, NY (US)

Correspondence Address: PARK, VAUGHAN & FLEMING LLP, 2820 FIFTH STREET, DAVIS, CA, 95618-7759, US

(21) Appl. No.: 11/497,206

(22) Filed: Jul. 31, 2006

(51) Int. Cl. G06F 17/00

(52) U.S. Cl. 715/255; 715/234

(57) ABSTRACT

One embodiment of the present invention provides a system that updates a document. During operation the system can receive a first document which was generated using a first set of data. The first document can include a first set of layout instructions which specify how to arrange the first set of data in the first document. The first document can also include a first set of template-processing instructions which specify how to update the first document. Next, the system can receive an update to the first set of data. The system can then apply the update to the first set of data to obtain a second set of data. Next, the system can generate a second document using the second set of data and the first set of template-processing instructions.

### FIELD OF THE INVENTION

The present invention generally relates to document processing. More specifically, the present invention relates to techniques for incrementally updating a web page.

### BACKGROUND

### Related Art

The incredible success of the WWW (World Wide Web) has been possible due to a number of important technologies. Template processing is one such technology which enables clean separation between the data and the layout of a web page.

A template specifies the layout of a web page. Template processing refers to the process of generating a web page using structured input data and the template. For example, template processing can be used to apply the same template to different sets of user-specific data to obtain personalized web pages.

In many web pages, a user action causes only incremental updates to the web page. For example, when a user clicks on a link that expands or collapses a list of items, the web page usually changes only in the area that is in proximity to the link.

Some prior art techniques handle user actions on the server side (e.g., static web pages). In these techniques, when a user clicks on a link, the client (e.g., web browser) usually sends the event information to the server, which processes the event and sends an updated web page back to the client. Note that the server may use template processing to generate the updated web page.

However, these techniques suffer from a number of drawbacks. First, the server typically regenerates the entire web page, and the client downloads and refreshes the entire web page even though only a small portion of the web page needs to be changed. Second, if the interval between the user's click and the web page update is too long (e.g., due to network latency), it can substantially degrade the user's web browsing experience.

To overcome these problems, recent prior art techniques handle user actions on the client side (e.g., dynamic web pages). In these techniques, when the client receives the web page, it also receives software code (e.g., JavaScript code) which can be used to handle user actions on the client side. When a user clicks on a link within a web page, the event can be handled by the client by executing an appropriate portion of the software code that was received with the web page. Note that these techniques can reduce the amount of communication required with the server, which can improve the web page's responsiveness.

Unfortunately, these recent prior art techniques also suffer from a serious drawback. Once the web server uses template processing to generate a web page, the clean separation between data and layout is lost. Furthermore, it is usually impossible to determine a template from the output web page.

The template is usually designed by a UI (user interface) designer using a template processing language (e.g., PHP, which is a popular server-side template processing language), but the software code that handles user actions is typically written in a different language (e.g., JavaScript, which is a popular scripting programming language) by a different person (e.g., an application developer). The software developer needs to be intimately familiar with the template so that he or she can write software code that correctly matches the template.

Note that changes to web pages are a frequent occurrence in the life cycle of a web application. Often, the effort spent on maintaining a web page is more than the effort spent on creating the web page. In prior art techniques, any changes to the template usually necessitate a corresponding change to the software code. However, if the person who changes the software code is not intimately familiar with the template, he or she may make changes that are inconsistent with the template. As a result, when a user clicks on a link, the software code may manipulate the web page content in a manner that is inconsistent with the template, which can lead to catastrophic results.

Hence, what is needed is a method and an apparatus to incrementally update a web page without the above-described problems.

### SUMMARY

One embodiment of the present invention provides a system that updates a document. During operation the system can receive a first document which was generated using a first set of data. The first document can include a first set of layout instructions which specify how to arrange the first set of data in the first document. The first document can also include a first set of template-processing instructions which specify how to update the first document. Next, the system can receive an update to the first set of data. The system can then apply the update to the first set of data to obtain a second set of data. Next, the system can generate a second document using the second set of data and the first set of template-processing instructions. The second document can include a second set of layout instructions which specify how to arrange the second set of data in the second document. Further, the second document can also include a second set of template-processing instructions which specify how to update the second document.

In a variation on this embodiment, the system can be used to incrementally update a web page. Specifically, the first document can be a valid HTML (HyperText Markup Language) document. Further, the second document can also be a valid HTML document. The first set of template-processing instructions can be embedded within HTML attributes.

In a variation on this embodiment, the second set of template-processing instructions can be equivalent to the first set of template-processing instructions. Specifically, contents of the first document can be generated using the first set of data and the first set of template-processing instructions. Further, contents of the second document can be generated using the second set of data and the second set of template-processing instructions. Additionally, contents of the first document can be generated using the first set of data and the second set of template-processing instructions.

In a variation on this embodiment, the first set of layout instructions can be specified using a layout language, and the first set of template-processing instructions can be specified using a template-processing language, which may be different from the layout language. Further, the first set of template-processing instructions can be embedded within the first set of layout instructions. Additionally, the first set of template-processing instructions are usually not displayed to a user. Note that including the first set of template-processing instructions in the first document by embedding them within the first set of layout instructions can facilitate a clean separation between the first document's data and layout.

In a variation on this embodiment, the system can extract the first set of template-processing instructions from the first document using the DOM (Document Object Model) API (Application Programming Interface). The system can then use the extracted template-processing instructions to generate the second document.

In a variation on this embodiment, the system can generate the second document by evaluating template-processing instructions. Specifically, the system can evaluate a template-processing instruction in a local context which is determined by the layout instructions within which the template-processing instruction is embedded.

In a variation on this embodiment, the system can be used to support an AJAX (Asynchronous JavaScript and XML) web application. Note that AJAX is a collection of web technologies for creating interactive web applications.

### BRIEF DESCRIPTION OF THE FIGURES

FIG. 1 illustrates a network which is coupled with a number of network nodes in accordance with an embodiment of the present invention.

FIG. 2A illustrates how template processing can be used to generate a web page.

FIG. 2B illustrates an example of using a template to generate a web page in accordance with an embodiment of the present invention.

FIG. 3 illustrates how software code can be received with a web page that can be used to handle user actions on the client side in accordance with an embodiment of the present invention.

FIG. 4 presents a flowchart that illustrates a process for incrementally updating a document in accordance with an embodiment of the present invention.

FIG. 5 illustrates how software code can be used to incrementally update a document in accordance with an embodiment of the present invention.

FIG. 6A-G illustrate how client-side template processing can be used to incrementally update a web page in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer readable media now known or later developed.

### Network

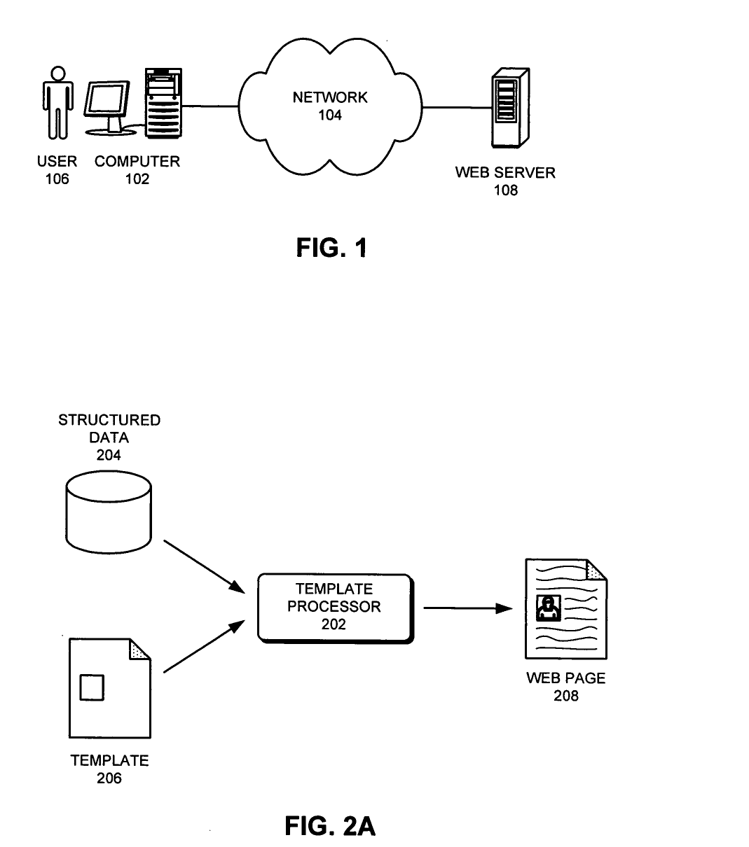

FIG. 1 illustrates a network which is coupled with a number of network nodes in accordance with an embodiment of the present invention.

Network 104 is coupled with computer 102 and web server 108. Network 104 can generally comprise any type of wire or wireless communication channel capable of coupling together network nodes. This includes, but is not limited to, a local area network, a wide area network, or a combination of networks, or other networks that enable communication between two or more computing systems. In one embodiment of the present invention, network 104 comprises the Internet.

A network node, such as a computer 102, can generally include any type of communication device capable of communicating with other network nodes via a network. This includes, but is not limited to, a computer system based on a microprocessor, a mainframe computer, a server, a printer, a video camera, an external disk drive, a router, a switch, a personal organizer, a mobile phone, or other computing system capable of processing data.

Network 104 allows a network node, such as, computer 102, to communicate with another network node, such as, web server 108. Specifically, user 106 can use a web browser on computer 102 to communicate with web server 108.

### Template Processing

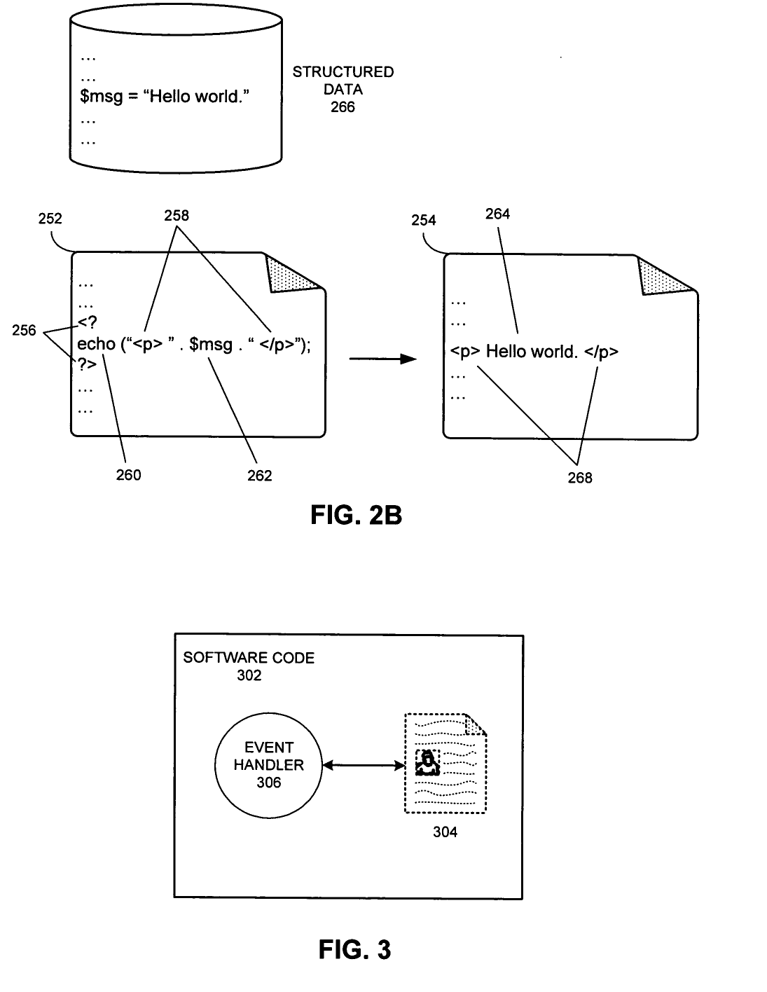

FIG. 2A illustrates how template processing can be used to generate a web page.

Template processor 202 can receive structured data 204 and template 206. Next, template processor 202 can generate web page 208 using the structured data 204 and the template 206.

Structured data 204 usually contains the data that needs to be presented in the web page, whereas template 206 usually specifies the layout of the web page.

In general, structured data 204 may contain data that is determined using a number of factors, such as the user's name, time of day, user's location, etc. In one embodiment, structured data 204 contains user-specific information. Specifically, when a user visits a web server, the web server can require the user to authenticate himself or herself. Next, the web server can determine the contents of structured data 204 based on the user's identity. For example, a user may save a list of addresses on the web server. When the user authenticates himself or herself, the web server can populate structured data 204 using the addresses that were saved by the user.

Structured data 204 can comprise a number of data sources. For example, structured data 204 can comprise a database. Alternatively, structured data 204 may comprise a data object which is specified using a programming language (e.g., JavaScript).

Template 206 usually contains instructions that specify how to layout the data in web page 208. For example, template 206 can specify fonts, colors, paragraph layout, tables, lists, sections, image locations, image sizes, etc. within the web page. Furthermore, template 206 can also specify how to obtain data from structured data 204. For example, template 206 may contain instructions for performing a database query that can be used by the template processor 202 to obtain data. Alternatively, template 206 may contain a variable name which can be used to access data within structured data 204.

FIG. 2B illustrates an example of using a template to generate a web page in accordance with an embodiment of the present invention.

Template 252 can comprise instructions that determine the layout of web page 254. Note that template 252 can contain instructions from two programming languages: a layout language and a template-processing language. The layout language instructions usually specify the overall layout of the web page, whereas the template-processing instructions are typically used by a template processor to generate the web page. For example, the layout language can be HTML, and the template-processing language can be PHP, which is a popular server-side template processing language.

Instructions (or tags) 256 can indicate the beginning and the end of template-processing instructions within the template. The template processor may execute only those instructions that are between such tags. Template-processing instruction 260 specifies that the template processor should evaluate the instruction's argument and print the result in place of the instruction. Instruction 260's argument is a concatenation of three strings. Strings 258 are layout language instructions or tags (e.g., HTML tags). Variable 262 may refer to an element in structured data 266. For example, the template processor may use structured data 266 to evaluate variable 262 to string 264. Note that the output of the template-processing instructions can comprise both data, such as, string 264, as well as layout language instructions, such as, instructions 268.

Although the above example involves simple variable substitution, template-processing instructions can be arbitrarily complex. In general, a template-processing language can be as powerful as a general purpose programming language. Furthermore, although in the above example the template-processing instruction is replaced in situ by the evaluated result, the result of executing template-processing instructions can generally affect any part of the web page. In other words, in general, the template processor may evaluate an expression and use the result to change the web page at a location which is different from the expression's location.

In prior art techniques, web page 254 does not contain the template-processing instructions (e.g., instruction 260) that were present in template 252. In other words, in prior art techniques, the clean separation between data and layout (e.g., structured data 266 and template 252) which existed before the web page was generated is lost because web page 254 contains layout instructions (e.g., tags 268) which are intermingled with data (e.g., string 264). Furthermore, in prior art techniques, the instructions or tags (e.g., tags 256) that are used to identify template-processing code are not part of the layout language, and hence may not be understood by the web client (e.g., web browser). In prior art techniques, these tags are usually understood only by the template processor. Hence, in prior art techniques, we cannot leave these template-processing instructions in the final web page. Further, in prior art techniques, if these instructions appear in the final web page they may have undesirable consequences, e.g., the instructions may be displayed to the user, or may cause undesirable changes to the layout. For these reasons, in prior art techniques, the generated web page (e.g., web page 254) cannot be used as a template.

There are a number of prior art techniques that perform template processing on the server side. However, these prior art techniques have drawbacks.

PHP instructions are typically embedded in an HTML document. However, the resulting template which contains both PHP instructions and HTML instructions is usually not a valid HTML document. Furthermore, PHP expressions are evaluated in a global context, and statements are executed in a flow of control that follows the page. PHP expressions are placeholders insofar as the value of an expression can, but doesn't have to be, inserted into the output at the place where the expression occurs, but nowhere else. (Further details on PHP may be available at http://www.php.net.)

XSLT (Extensible Stylesheet Language Transformations) is available on both the server side and the client side. However, the input document format in XSLT is completely different from the output format, and in common usage patterns, the input format does not even structurally resemble the output format. (Further details on XSLT may be available at http://www.w3.org/TR/xslt.)

ClearSilver is only available on the server side. However, like PHP, the template document may not be a valid HTML document. (Further details on ClearSilver may be available at http://www.clearsilver.net.)

Some prior art techniques may not support hierarchical input data and/or they may not support an evaluation context that is more local than a “per template file” evaluation context. Furthermore, some prior art techniques do not use a “real” template-processing language; instead, these techniques simply replace placeholders with dictionary values. Additionally, some prior art techniques may be agnostic to the document structure and may violate the document's wellformedness during template processing.

In contrast to prior art techniques, the present invention provides techniques and systems that enable a web page to be used as a template. If a web page is used as a template and is processed again with the identical input data, it generates a web page which is equivalent to the original web page. On the other hand, if the web page is reprocessed with changed input data, the output reflects this change. This is an important aspect of the present invention which supports interactive incremental page updates. Furthermore, since the output web page can be used as a template, it simplifies the creation of application UI templates from “mockups,” and supports round-trip engineering of the web page layout over multiple mockup/template iterations. (Note that a “mockup” can be a non-interactive sketch of the visual appearance of the UI of an interactive application, which is usually produced by a UI designer.)

Embodiments of the present invention can be processed at the server side as well as the client side. Additionally, embodiments of the present invention can embed template-processing instructions within an HTML document so that the resulting document is a valid HTML document. Furthermore, note that embodiments of the present invention preserve “wellformedness.” In other words, in the present invention, it is impossible to create a “non-wellformed” output from a “wellformed” input template.

Note that embodiments of the present invention do not use placeholder expressions. In the present invention, the processing instructions that associate input data with the template output do not cover the places in the template where the output will appear. This makes it possible for the unprocessed template to contain meaningful example text rather than placeholder tokens. This property of the present invention supports iterative round trip design between mockup specification and behavior implementation.

Additionally, since embodiments of the present invention maintain local context, they support processing of covariant hierarchical data. In the present invention, the template specifies at every place a local evaluation context in which expressions are evaluated. Hence, in embodiments of the present invention, a template that creates hierarchical output from a hierarchical input data structure can therefore contain very simple expressions, because the input hierarchy is expressed by the output hierarchy and does not need to be redundantly repeated in the template expressions.

### Client Side Processing

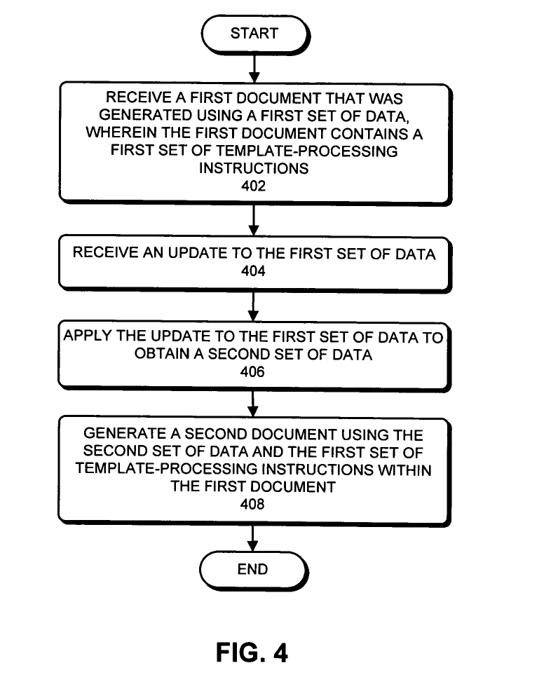

FIG. 3 illustrates how software code can be received with a web page that can be used to handle user actions on the client side in accordance with an embodiment of the present invention.

A client can receive software code 302 with a web page which can be used by the client to process user actions without communicating with the web server. This technique can substantially improve the responsiveness of the web application.

Software code 302 can contain a web page model 304 which can be used by software code 302 to manipulate the web page's content. In one embodiment, web page model 304 can be described using a standardized object model that has a standardized API (Application Programming Interface) which can be used to access and manipulate objects within the object model. For example, the system can represent the web page using DOM (Document Object Model).

User actions (e.g., mouse clicks) can be processed by event handler 306 within software code 302. Event handler 306 can contain code which is written in a scripting programming language (e.g., JavaScript). The web client can generate an event object whenever a user performs an action (e.g., when the user clicks on a link). The event object usually contains information which is required for handling the event. The web client can then invoke the event handler and pass the event object as an argument. The event handler can execute an appropriate piece of code (e.g., a method) to handle the user's action. Specifically, in response to the user's action, event handler 306 may modify a section of the web page. Event handler 306 can use web page model 304 to make changes to the web page. Specifically, event handler 306 can change a portion of the web page by invoking certain methods in the associated DOM object. The new content can be provided as an argument to the DOM object's methods, which can change the contents of the web page.

Unfortunately, prior art techniques to process user actions on the client side suffer from a serious drawback. Specifically, in prior art techniques, when a user clicks on a link, the software code may manipulate the web page content in a manner that is inconsistent with the template, which can lead to catastrophic results.

In contrast to these prior art techniques, embodiments of the present invention retain the original template-processing instructions that were created by the UI designer. The application developer who creates the event handlers uses the embedded template-processing instructions to incrementally update the web page in response to user actions. In other words, the present invention guarantees that the software code that manipulates the web page content on the client is consistent with the template-processing instructions that were used to create the web page on the web server.

### A Process for Incrementally Updating a Document

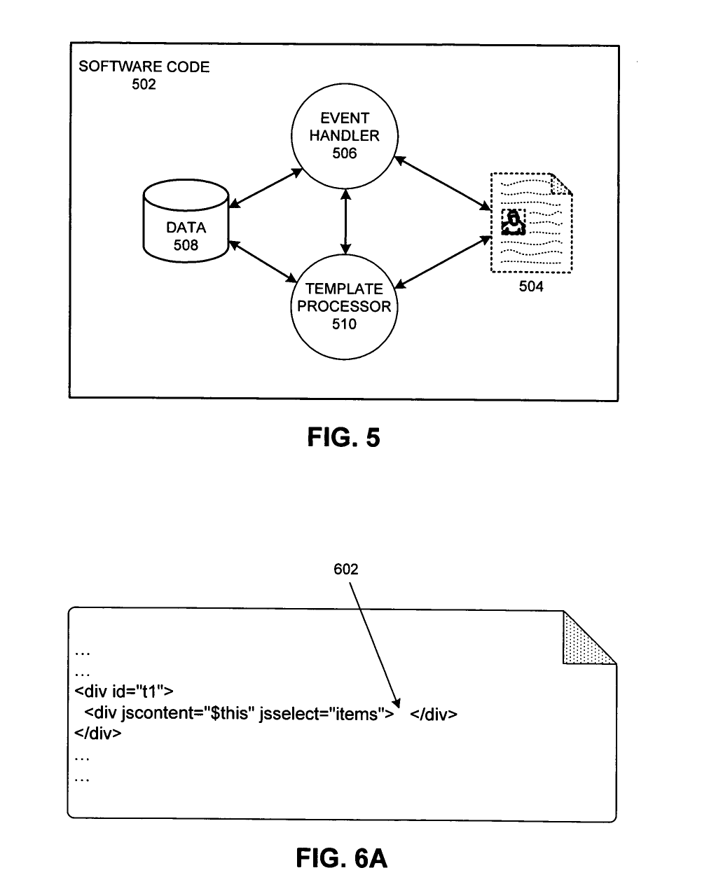

FIG. 4 presents a flowchart that illustrates a process for incrementally updating a document in accordance with an embodiment of the present invention.

The process typically begins by receiving a first document which was generated using a first set of data (step 402).

The first document can include a first set of layout instructions which specify how to arrange the first set of data within the first document. The first document can also include a first set of template-processing instructions which specify how to create the first document using the first set of data.

One embodiment of the present invention specifies a method to embed template-processing instructions within a web page. Specifically, the embodiment uses the layout language to embed the template-processing instructions that were used to generate the web page. Note that the template-processing instructions in the output document may not be visible to the user, or affect the format of the web page in a visible manner. For example, the template-processing instructions can be stored using attributes of HTML elements.

Many websites store user-specific data to enhance the user's web-browsing experience. Specifically, a user may save a list of addresses on a website which are associated with keywords or abbreviations that the user is familiar with. The user can then use these keywords or abbreviations for performing operations on the website. For example, a website can associate the keyword “home” with a user's home address. When the user wants to get directions from his or her home address, the user can simply refer to the home address using the keyword “home,” instead of providing the full street address.

In this example, when a user visits the website, the web server can generate the web page using a first set of data, e.g., a list of addresses associated with the user.

Continuing with the flowchart in FIG. 4, the system receives an update to the first set of data (step 404).

The system then applies the update to the first set of data to obtain a second set of data (step 406).

For example, the client can allow the user to edit the address list. When the user clicks on an address in the list, the client can open a form which enables the user to modify the address. Note that except for the change in the address, the rest of the web page remains the same.

Next, the system generates a second document using the second set of data and the first set of template-processing instructions within the first document (step 408).

The second document can include a second set of layout instructions which specify how to arrange the second set of data within the second document. The second document can also include a second set of template-processing instructions which specify how to generate the second document using the second set of data.

In one embodiment, the second set of template-processing instructions are equivalent to the first set of template-processing instructions. Specifically, the second set of template-processing instructions can be used to generate the contents of the first document from the first set of data. Similarly, the first set of template-processing instructions can be used to generate the contents of the second document from the second set of data.

For example, the system can use the updated list of addresses to generate a portion of the web page. Specifically, the system can incrementally update the web page by applying the template-processing instructions embedded within the web page to the updated list of addresses.

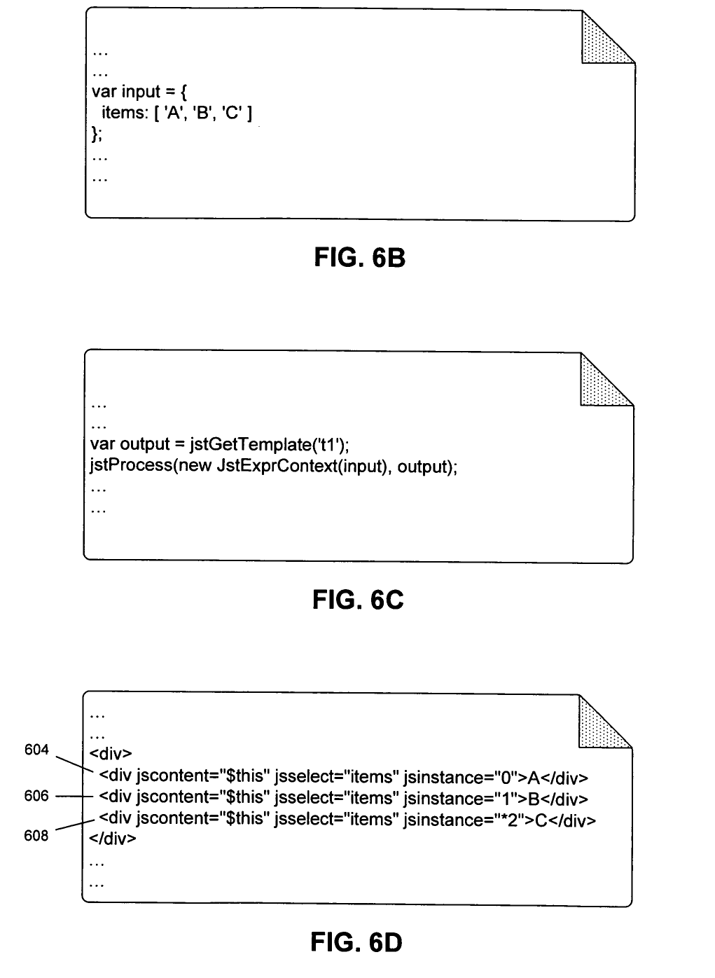

FIG. 5 illustrates how software code can be used to incrementally update a document in accordance with an embodiment of the present invention.

Software code 502 can be received with a web page to facilitate incremental updates. Software code 502 can contain a web page model 504 which can be used by software code 502 to manipulate the web page's content. In one embodiment, web page model 504 can be described using a standardized object model that has a standardized API to access and manipulate objects within the object model. For example, the system can represent the web page using DOM.

Data 508 contains the data that is used to generate the web page. For example, data 508 can contain a list of addresses. Note that in prior art techniques, the data within the web page is intermingled with the layout. However, in the present invention, data 508 within software code 502 contains the data for the web page, whereas the web page model 504 contains the template-processing instruction, thereby facilitating a clean separation between the data and the layout.

User actions (e.g., mouse clicks) can be processed by event handler 506 within software code 502. Event handler 506 can contain code which is written in a scripting programming language (e.g., JavaScript). The web client can generate an event object whenever a user performs an action (e.g., when the user clicks on a link). The event object usually contains information which is required for handling the event. The web client can then invoke the event handler and pass the event object as an argument. The event handler can execute an appropriate piece of code (e.g., a method) to handle the user's action.

In contrast to prior art techniques, embodiments of the present invention (e.g., software code 502) maintain a clean separation between web page's layout and the web page's data. Specifically, in contrast to prior art techniques, event handler 506 does not directly operate on the web page's content. Instead, in response to a user action, event handler 506 updates data 508. Next, event handler invokes template processor 510 to generate an updated version of the web page content. Specifically, template processor 510 uses the web page as a template and applies the template to the updated data 508. Event handler 506 or template processor 510 can use web page model 504 to make changes to the web page. Specifically, event handler 506 or template processor 510 can change a portion of the web page by invoking a method in the associated DOM object. The new content can be provided as an argument to the DOM object's method, which can change the contents of the web page. Note that, since prior art techniques cannot use the web page as template, they cannot use a template processor to incrementally update a web page.

For example, in prior art techniques, if we change an entry in the address book, the event handler would determine an object handle for the table cell and replace its value with the new value. Further, in prior art techniques, if there are multiple instances of a data item (i.e., same data element appears at multiple locations in the web page), the event handler would require code that identifies all of these instances and then updates each instance with the new value. For these reasons, in prior art techniques, the application developer who writes the event handler code has to be intimately familiar with the web page's layout.

In contrast to prior art techniques, embodiments of the present invention may have a data source (e.g., data 508) that contains the web page's data. The event handler may update the data elements in this data source. The rest of the operations can be performed by the template processor. Specifically, the system can rerun the template processor with the updated data source. The template processor can automatically populate the updated data elements at the appropriate locations in the web page. Hence, in contrast to prior art techniques, the application developer who wrote the event handling code for an embodiment of the present invention does not have to be intimately familiar with the web page layout.

### An Illustrative Example

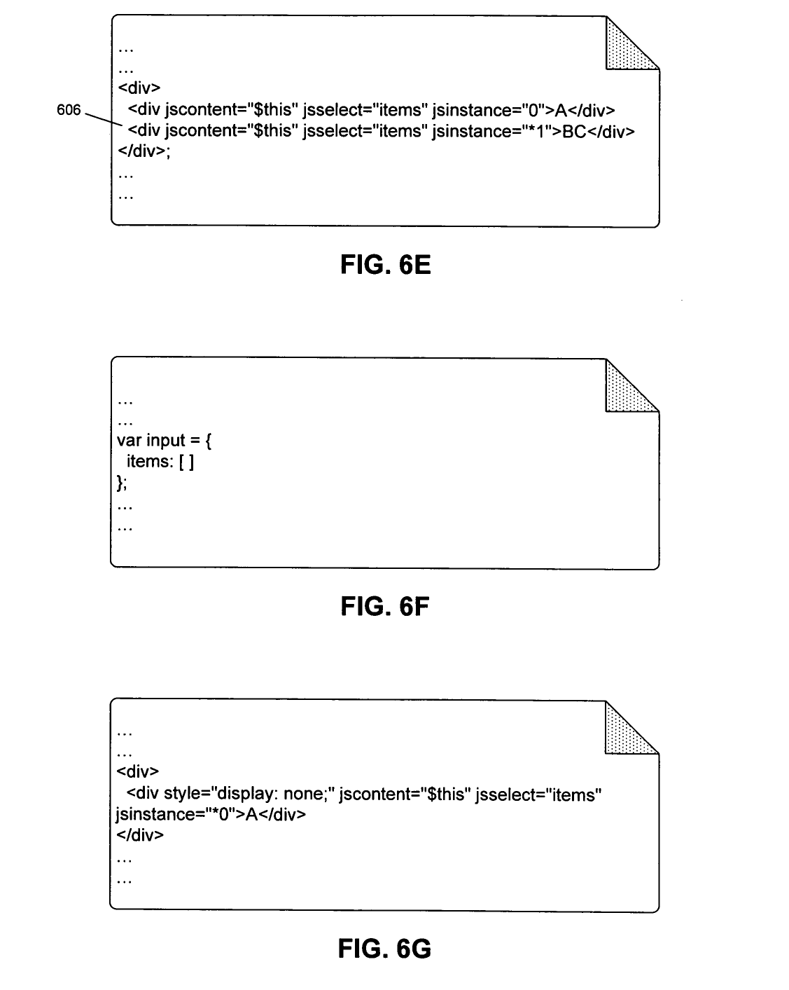

FIG. 6A-G illustrate how client-side template processing can be used to incrementally update a web page in accordance with an embodiment of the present invention.

One embodiment of the present invention uses HTML attributes to store the template-processing instructions so that they are not visible to the user. HTML attributes are typically used for defining specific aspects of the HTML page, such as, the URL (Universal Resource Locator) a hyperlink refers to, or the URL from where images are loaded. Specifically, one embodiment uses user-defined attributes on existing HTML elements to store template-processing instructions. Note that the embodiment does not define new tags; instead, the embodiment defines new attributes on existing tags.

FIG. 6A illustrates a portion of an output web page which contains template-processing instructions. Note that the “<div>” tag is a standard HTML tag that is used to divide a document into different sections. The “jscontent” and “jsselect” attributes are user defined attributes that the present invention uses to instruct the template processor to insert particular data values at location 602. In contrast to some prior art techniques, template-processing instructions in the present invention change the web page content at a location that is different from the location of the template-processing instructions. In other words, the present invention does not involve simple variable substitution.

The attribute jscontent=“$this” instructs the template processor to evaluate the expression “$this” and insert the result between the “<div>” and “</div>” tags so that the result will be visible to the user. Note that the variables are not visible in the final HTML document. Hence, if we simply substitute the variables with corresponding values, they will also not be visible to the user.

Embodiments of the present invention support hierarchical data structures. For example, FIG. 6B illustrates data structure “input” which contains an array called “items” which is a list of three elements, namely, “A,” “B,” and “C.” When the system walks through a hierarchical data structure, the “$this” variable points to the current node.

FIG. 6C illustrates how template-processing instructions embedded within a web page can be extracted. The code fragment illustrated in FIG. 6C may be implemented within event handler 506. Specifically, the “jstGetTemplate” function extracts the template from the web page. The argument to this function can be an identifier which is associated with the outermost element of the template. For example, the identifier “t1” can be provided to the “jstGetTemplate” function so that it can locate the template shown in FIG. 6A. Note that “id” is a common attribute that is used in HTML to associate blocks of layout instructions with an identifier.

Function “jstProcess” can take two input arguments. The first argument is the data source which may be provided in the form of a reference to an object that contains the data. The second input is the template which was extracted from the web page. The function “jstProcess” applies the template to the data source. In one embodiment “jstProcess” may invoke template processor 510.

FIG. 6D illustrates the output after the template-processing instructions shown in FIG. 6A are applied to the data shown in FIG. 6B. The output contains the three elements in the “items” array. The template processing instructions have been retained which can be used to format the data if it changes.

Note that the template-processing instructions in the output shown in FIG. 6D are different from the template-processing instructions in the original document shown in FIG. 6A. However, these sets of template-processing instructions are equivalent and will result in the same output.

Attribute “jsinstance” shown in FIG. 6D indicates that the present template processing instruction is to be applied to an instance of the array “item.” The “*” symbol in the last line in FIG. 6D specifies that this template processing instruction should be applied to the third element of the array “item” and also to further elements in the array “item.”

FIG. 6E illustrates the output when the template-processing instructions shown in FIG. 6D are applied to a new array with only two items, “A” and “BC.” The first line 604 of template-instructions in FIG. 6D is applied to the first element (“A”), the second line 606 is applied to the second element (“BC”), and since that is the end of the array, the third line 608 is not applied.

The second line in the output document shown in FIG. 6E contains the “*” symbol which indicates that this template-processing instruction should be applied if a new (e.g., third) element is added to the array.

When the template-processing instructions shown in FIG. 6E are applied to an empty array which is shown in FIG. 6F, the system may use the HTML attribute “style” to ensure that data elements present in the output file are not displayed.

FIG. 6G illustrates the output when the template-processing instructions embedded in the document shown in FIG. 6E are applied to the empty array shown in FIG. 6F. Note that the attribute “style” has been assigned a value “display: none;” to ensure that data element “A” is not displayed when the document shown in FIG. 6G is viewed using a web browser.

### Template Processing Language

The following descriptions provide details for one embodiment of the present invention. They are not intended to be exhaustive or to limit the present invention to the forms disclosed. Accordingly, many modifications and variations will be apparent to practitioners skilled in the art.

### Template Format and Processing Instructions

In one embodiment of the present invention, “jstemplate” is an HTML fragment identified by an identifier. The HTML fragment can be presented to the template processor as a DOM node. The processing instructions, which tell the template processor how to inject the input data into the template, can be embedded into the template as custom attributes. Typically, no values of existing HTML attributes, or content of existing HTML elements, are used to store processing instructions. However, processing instructions may instruct the template processor to replace attribute value or element content that is present in the template. This may be desirable because the template, which, as long as it is not processed, is well-formed HTML, and can show meaningful example text and attribute values instead of meaningless placeholder tokens. The custom attributes used to store template processing instructions can include jscontent, jsvalues, jsselect, jsdisplay, transclude. Internally, another attribute jsinstance is used.

### Template Processing Details

The input data and the template can be passed to the template processor as arguments to the function jstProcess (context, output). The input data can be wrapped into an instance of the class JsExprContext. This object can provide the context for evaluation of the expressions contained in the template processing instruction attributes, and besides the input data can contain global variable definitions. In order to initially instantiate a template, a corresponding DOM data structure can be replicated using cloneNode ( ) or importNode ( ), depending on where the template is taken from. This can be achieved using the helper function jstGetTemplate (id). The template processor can operate directly on the DOM of the output. This has the advantage that additional properties defined in the output DOM, such as, JavaScript properties, or event handlers, can survive the template processing, thereby supporting incremental updates.

### Processing Context

The JsExprcontext can be created with a root node as the parameter of the constructor. A method setVariable (name, value) can also be provided which allows to inject additional globally accessible values in the evaluation context. Names used in setVariable ( ) can be used in javascript expressions in the template processing instructions.

“jsselect” Attribute

The jsselect attribute can contain a JavaScript expression. This expression can be evaluated in the current context, and its value can be the evaluation context for evaluating of all template processing expressions in descendants of the current template node. If the value of the jsselect expression is an array, the current template node can be replicated for each element of the array, with that element as the current context. This attribute can be evaluated before all other attributes on a node, and hence can reset the evaluation context also for the expressions of the other attributes of the same template node.

“jsdisplay” Attribute

The value of this attribute is evaluated as a Boolean, and if true, the template node is outputted, otherwise not. To be precise, the node is still outputted, in order to allow reprocessing, but its CSS (Cascading Style Sheets) display property value is set to none.

“jscontent” Attribute

The value of this attribute can be evaluated as text and can set the content of this node as text. The children of this template node are usually not processed any further. Note that the content of this node is set to the value as text, i.e., no markup is processed in the content.

“jsvalues” Attribute

The value of this variable can be a semicolon-separated list of target-expression pairs. A target and an expression are separated by a colon. The expressions are evaluated in the current evaluation context, and assigned to the specified target, as follows: if the name of the target starts with a dollar sign ($), the value is set as a variable in the current evaluation context. This variable may be available in all expressions in all descendants of the current template node, and in subsequent expressions in the same “jsvalues” attribute. If the name of the target starts with a dot (.), then the value is assigned to the JavaScript property of the current template DOM node. Otherwise, the target is the HTML attribute of the same name of the current template node, which is set to the string value of the expression.

“transclude” Attribute

The current template node is replaced by a clone of the node from the same document with the “id” of the value of this attribute, and template processing is continued on that node, thus “transcluding” a template fragment into this template. The name of the attribute doesn't start with “js,” because its value is not a JavaScript expression, but only an HTML “id” value. If no node with the given “id” is found, the template node can be removed. The attribute can be removed from the output because it may not be needed for reprocessing. Note that template processing instruction attributes on the “transcluded” node will be evaluated. However, no other attributes are evaluated on a node that carries a “transclude” attribute.

### Special Variables

One special variable is “$this,” which is the current evaluation context as defined by jsselect or initially the constructor argument to JsExprContext. Another special variable is “$index,” wherein if the last jsselect was an array, the index of the element of that array that is the current evaluation context.

### Reprocessing and Cardinality

The output can maintain all template-processing instruction attributes of the original template. Thus, template processing can be reapplied to the output. In order to accommodate changing cardinalities in the input data, a special attribute is added to the output that results from multiplication of template node according to the cardinality of a jsselect expression. Specifically, the index of the element is added as the value of the jsinstance attribute. The last element of the array is marked by a “*” in the jsinstance value. Moreover, if a jsselect expression evaluates to an array with zero elements, the template node is not dropped (i.e., multiplied zero times), but a single instance is kept which is not displayed. This ensures that subsequent reprocessing with a non-zero number of elements will work. These conventions allow the template to be reprocessed with a changed number of instances in repeated input elements.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art.

For example, a variation on the above-described embodiments can perform the initial processing on the server and send the output file which contains the template-processing instructions embedded within the output file to the client which then updates the file according to user input.

Another variation can perform all the computations on the server. Hence, every time the user clicks on a link, the system can send the event to the server, which can re-compute the web page using the embedded template-processing instructions and then returns the updated web page to the client. However, this approach may not be preferable because it goes against the motivation for performing the update processing on the client side.

The above disclosure is not intended to limit the present invention. The scope of the present invention is defined by the appended claims.

What is claimed is:

1. A method to update a document, the method comprising:
receiving a first document which was generated using a first set of data, wherein the first document includes:
a first set of layout instructions which specify how to arrange the first set of data in the first document; and
a first set of template-processing instructions which specify how to update the first document;
receiving an update to the first set of data;
applying the update to the first set of data to obtain a second set of data; and
generating a second document using the second set of data and the first set of template-processing instructions.

2. The method of claim 1, wherein the second document includes:
a second set of layout instructions which specify how to arrange the second set of data in the second document; and
a second set of template-processing instructions which specify how to update the second document.

3. The method of claim 2,
wherein the second set of template-processing instructions are equivalent to the first set of template-processing instructions;
wherein contents of the first document can be generated using the first set of data and the first set of template-processing instructions;
wherein contents of the second document can be generated using the second set of data and the second set of template-processing instructions;
wherein contents of the first document can be generated using the first set of data and the second set of template-processing instructions.

4. The method of claim 1,
wherein the first set of layout instructions are specified using a layout language;
wherein the first set of template-processing instructions are specified using a template-processing language, which is different from the layout language;
wherein the first set of template-processing instructions are embedded within the first set of layout instructions;
wherein the first set of template-processing instructions are not displayed to a user;
wherein including the first set of template-processing instructions in the first document by embedding them within the first set of layout instructions facilitates a clean separation between the first document's data and layout.

5. The method of claim 1, wherein generating the second document involves extracting the first set of template-processing instructions from the first document using the DOM (Document Object Model) API (Application Programming Interface).

6. The method of claim 1,
wherein the method is used to incrementally update a web page;
wherein the first document is a valid HTML (HyperText Markup Language) document;
wherein the first set of template-processing instructions are embedded within HTML attributes;
wherein the second document is a valid HTML document.

7. The method of claim 1, wherein generating the second document involves evaluating a template-processing instruction in a local context which is determined by the layout instructions within which the template-processing instruction is embedded.

8. A computer-readable storage medium storing instructions that when executed by a computer cause the computer to perform a method to update a document, the method comprising:
receiving a first document which was generated using a first set of data, wherein the first document includes:
a first set of layout instructions which specify how to arrange the first set of data in the first document; and
a first set of template-processing instructions which specify how to update the first document;
receiving an update to the first set of data;
applying the update to the first set of data to obtain a second set of data; and
generating a second document using the second set of data and the first set of template-processing instructions.

9. The computer-readable storage medium of claim 8, wherein the second document includes:
a second set of layout instructions which specify how to arrange the second set of data in the second document; and
a second set of template-processing instructions which specify how to update the second document.

10. The computer-readable storage medium of claim 9,
wherein the second set of template-processing instructions are equivalent to the first set of template-processing instructions;
wherein contents of the first document can be generated using the first set of data and the first set of template-processing instructions;
wherein contents of the second document can be generated using the second set of data and the second set of template-processing instructions;
wherein contents of the first document can be generated using the first set of data and the second set of template-processing instructions.

11. The computer-readable storage medium of claim 8,
wherein the first set of layout instructions are specified using a layout language;
wherein the first set of template-processing instructions are specified using a template-processing language, which is different from the layout language;
wherein the first set of template-processing instructions are embedded within the first set of layout instructions;
wherein the first set of template-processing instructions are not displayed to a user;
wherein including the first set of template-processing instructions in the first document by embedding them within the first set of layout instructions facilitates a clean separation between the first document's data and layout.

12. The computer-readable storage medium of claim 8, wherein generating the second document involves extracting the first set of template-processing instructions from the first document using the DOM (Document Object Model) API (Application Programming Interface).

13. The computer-readable storage medium of claim 8,
wherein the method is used to incrementally update a web page;
wherein the first document is a valid HTML (HyperText Markup Language) document;
wherein the first set of template-processing instructions are embedded within HTML attributes;
wherein the second document is a valid HTML document.

14. The computer-readable storage medium of claim 8, wherein generating the second document involves evaluating a template-processing instruction in a local context which is determined by the layout instructions within which the template-processing instruction is embedded.

15. A apparatus to update a document, the apparatus comprising:
a document-receiving mechanism configured to receive a first document which was generated using a first set of data, wherein the first document includes:
a first set of layout instructions which specify how to arrange the first set of data in the first document; and
a first set of template-processing instructions which specify how to update the first document;
an update-receiving mechanism configured to receive an update to the first set of data;
an applying mechanism configured to apply the update to the first set of data to obtain a second set of data; and
a generating mechanism configured to generate a second document using the second set of data and the first set of template-processing instructions.

16. The apparatus of claim 15, wherein the second document includes:
a second set of layout instructions which specify how to arrange the second set of data in the second document; and
a second set of template-processing instructions which specify how to update the second document.

17. The apparatus of claim 16,
wherein the second set of template-processing instructions are equivalent to the first set of template-processing instructions;
wherein contents of the first document can be generated using the first set of data and the first set of template-processing instructions;
wherein contents of the second document can be generated using the second set of data and the second set of template-processing instructions;
wherein contents of the first document can be generated using the first set of data and the second set of template-processing instructions.

18. The apparatus of claim 15,
wherein the first set of layout instructions are specified using a layout language;
wherein the first set of template-processing instructions are specified using a template-processing language, which is different from the layout language;
wherein the first set of template-processing instructions are embedded within the first set of layout instructions;
wherein the first set of template-processing instructions are not displayed to a user;
wherein including the first set of template-processing instructions in the first document by embedding them within the first set of layout instructions facilitates a clean separation between the first document's data and layout.

19. The apparatus of claim 15, wherein the generating mechanism is configured to extract the first set of template-processing instructions from the first document using the DOM (Document Object Model) API (Application Programming Interface).

20. The apparatus of claim 15,
wherein the apparatus is used to incrementally update a web page;
wherein the first document is a valid HTML (HyperText Markup Language) document;
wherein the first set of template-processing instructions are embedded within HTML attributes;
wherein the second document is a valid HTML document.

21. The apparatus of claim 15, wherein the generating mechanism is configured to evaluate a template-processing instruction in a local context which is determined by the layout instructions within which the template-processing instruction is embedded.
